(19) United States
(12) Patent Application Publication
(10) Pub. No.: US 2005/0092338 A1
(43) Pub. Date: May 5, 2005

(54) Cosmetic pencil

(75) Inventor: Giuseppe Lattanzi, Desio (IT)

Correspondence Address: OSTROLENK FABER GERB & SOFFEN, 1180 AVENUE OF THE AMERICAS, NEW YORK, NY, 100368403, US

(73) Assignee: Interfila S.r.1

(21) Appl. No.: 10/941,112

(22) Filed: Sep. 15, 2004

(30) Foreign Application Priority Data
Sep. 16, 2003 (IT) TO2003U000140

(51) Int. Cl. B26B 13/22

(52) U.S. Cl. 132/73.5; 132/318

(57) ABSTRACT

A cosmetic pencil has a substantially cylindrical supporting body, and a cosmetic lead housed inside the supporting body so as to project from a first end of the supporting body at least in an in-use configuration; and a second end, opposite the first end, of the supporting body is fitted with a manicure implement.

The present invention relates to a cosmetic pencil.

### BACKGROUND OF THE INVENTION

As is known, increasing need is felt to reduce the size of numerous cosmetic products, many of which must be easy to carry and use even outside the home or beauty salons. Certain jobs, in particular, call for a well groomed appearance for prolonged periods of time, so it is important to have the necessary instruments at one's disposal to repair face make-up, even only slightly, but frequently, and perform minor manicure operations.

As is known, pencils or propelling pencils for applying cosmetics are among the most widely sold cosmetic products, and, being small and of more or less negligible weight, can be carried easily in a small bag or holder for use in practically any situation. Known cosmetic pencils, however, are designed solely for applying facial, in particular eye and lip, products, and are unsuitable for manicure purposes. As a result, separate specific manicure implements must normally also be carried, and which are bulky and awkward to use.

### SUMMARY OF THE INVENTION

It is an object of the present invention to provide a cosmetic pencil designed to eliminate the aforementioned drawbacks, and which in particular is compact and also provides for performing manicure operations.

According to the present invention, there is provided a cosmetic pencil comprising a substantially cylindrical supporting body; and a cosmetic lead housed inside the supporting body so as to project from a first end of the supporting body at least in an in-use configuration; characterized in that a second end, opposite the first end, of the supporting body is fitted with a manicure implement.

In short, the cosmetic pencil according to the invention combines a cosmetic lead and a manicure implement in one support. The cosmetic lead may be used as facial (eye, lip) and possibly also nail make-up (whitener), and the manicure implement for hand care. One pencil may thus be used to advantage for both face and hands, and at the same time is compact and therefore easy to carry for use in any situation.

According to a further aspect of the invention, the manicure implement comprises a cuticle cutter.

Cuticles are annoying and unsightly, and call for frequent attention. Occasional removal in fact is not enough, in that cuticles tend to grow back rapidly, especially if not removed properly. The pencil according to the invention advantageously provides a cuticle cutter which is easy to carry and use, and permits constant cuticle care.

According to a further aspect of the present invention, the manicure implement is fitted removably to the second end of the supporting body.

The manicure implement may thus be replaced easily in the event of breakage; different manicure or additional face and eye grooming implements may be carried, whose size is practically negligible with respect to the supporting body; and the implements may be fitted interchangeably to the same supporting body for performing various manicure operations.

According to a further aspect of the invention, the lead is retractable inside the supporting body.

The lead is thus protected against breakage when the pencil is not in use.

### BRIEF DESCRIPTION OF THE DRAWINGS

A number of non-limiting embodiments of the present invention will be described by way of example with reference to the accompanying drawings, in which:

FIG. 1 shows an exploded, partly sectioned, top plan view of a first embodiment of a cosmetic pencil in accordance with the present invention;

FIG. 2 shows an exploded side view of the cosmetic pencil in FIG. 1;

FIG. 3 shows a larger-scale, longitudinally sectioned side view of a variation of the FIGS. 1 and 2 pencil;

FIG. 4 shows a partly sectioned side view of a second embodiment of a cosmetic pencil in accordance with the present invention.

### DETAILED DESCRIPTION OF THE INVENTION

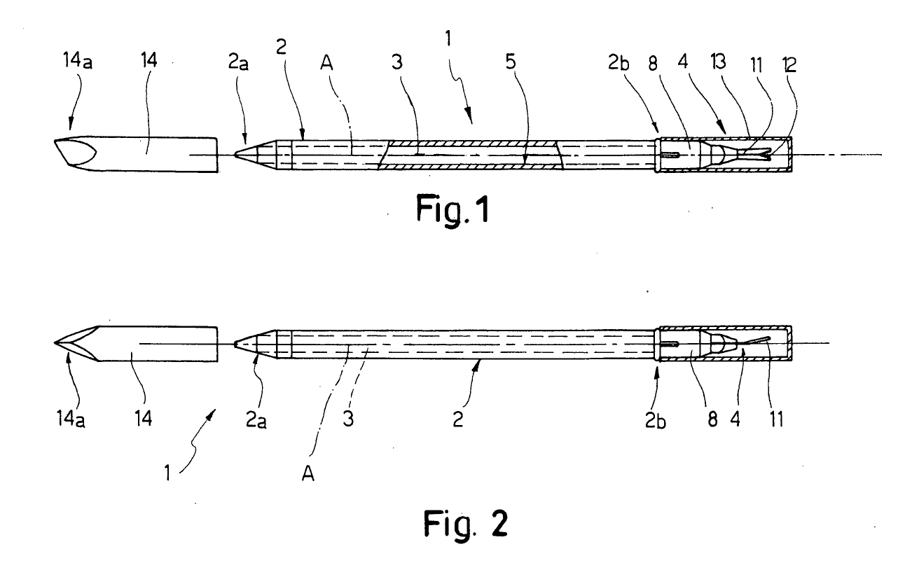

With reference to FIG. 1, a cosmetic pencil, indicated as a whole by 1, comprises a substantially cylindrical supporting body 2 of axis A; a cosmetic lead 3; and a manicure implement 4.

In the non-limiting example shown, supporting body 2, by which cosmetic pencil 1 is gripped for use, is formed in one piece from lacquered wood, and comprises a longitudinal inner seat 5 housing cosmetic lead 3. More specifically, cosmetic lead 3 is locked inside seat 5 and, at least in an in-use configuration, projects partly from one end 2a of supporting body 2 (during manufacture, cosmetic lead 3 may in fact be cut flush with end 2a, and does not project from supporting body 2, so cosmetic pencil 1 must obviously be sharpened prior to use to expose a long enough portion of cosmetic lead 3). Cosmetic lead 3 preferably contains a cosmetic substance for the face, in particular the eyes or lips. Alternatively, cosmetic lead 3 is a nail whitener.

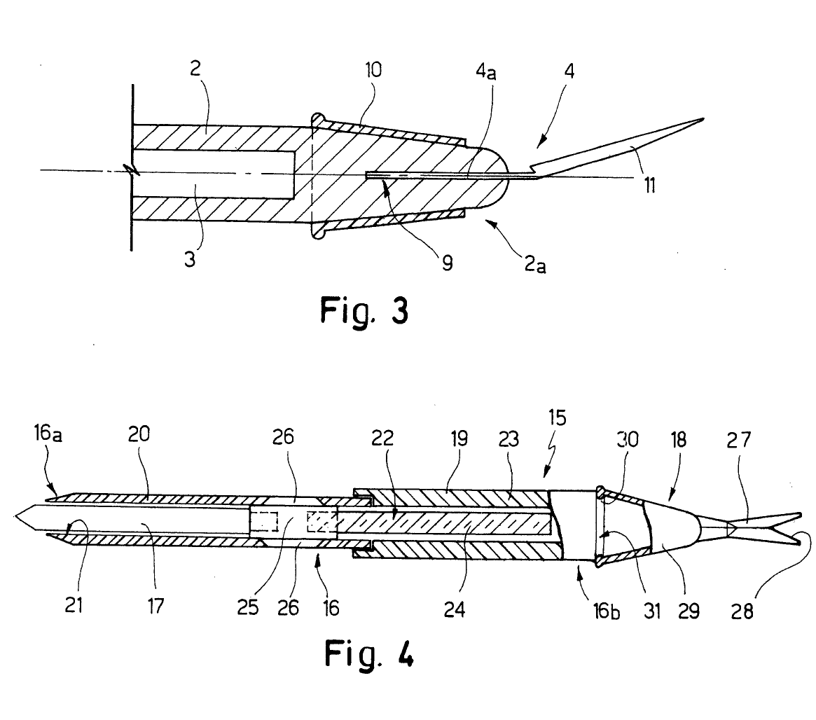

Implement 4 is fitted to an end 2b, opposite end 2a, of supporting body 2. More specifically, in the FIG. 1 embodiment, implement 4 comprises a base 8 fitted and glued to end 2b of supporting body 2, and extends substantially axially from supporting body 2. In the FIG. 3 variation, implement 4 has a root portion 4a inserted inside a slit 9 in end 2b of supporting body 2; and a collar 10, force-fitted and glued to end 2b, locks root portion 4a in place to prevent detachment of implement 4.

Implement 4 also comprises a cuticle cutter 11. More specifically, cutter 11 comprises a V-shaped blade 12 open in the opposite direction to supporting body 2 and bent slightly away from axis A. To use implement 4, cosmetic pencil 1 is pushed axially to move cutter 11 forward; the shape of blade 12 provides for gathering in the cuticle, which is cut at the vertex of blade 12; and the bend angle of blade 12 makes cutter 11 easier to use.

Implement 4 is protected by a cap 13 made, for example, of transparent plastic material.

In the non-limiting example described, cosmetic pencil 1 is also fitted with a lead cap 14 fitted removably to end 2a of supporting body 2 to protect cosmetic lead 3 when cosmetic pencil 1 is not in use. A closed portion 14a of lead cap 14 is in the form of a spatula, in particular of the type used to push back or raise the cuticles to assist removal by cutter 11, or for cleaning the nails.

In an alternative embodiment of the invention shown in FIG. 4, a cosmetic pencil 15 comprises a supporting body 16, a cosmetic lead 17, and a manicure implement 18 similar to implement 4 in FIGS. 1 and 2, but in this case cosmetic lead 17 is retractable inside supporting body 16.

More specifically, supporting body 16 comprises two plastic tubular members 19, 20 connected end to end and movable angularly with respect to each other. Tubular members 19, 20 define an inner seat 21, in which cosmetic lead 17 slides, and house a feed mechanism 22 for advancing cosmetic lead 17 with respect to supporting body 16.

In the non-limiting example described, mechanism 22 comprises a nut screw 23, a screw 24, and a lead-holder sleeve 25. Nut screw 23 is an internally threaded sleeve interference-fitted inside, and therefore angularly fixed with respect to, tubular member 19. Screw 24 is fitted to nut screw 23 and secured integrally at one end to sleeve 25, which is turn is connected in angularly fixed, axially sliding manner to tubular member 20 in known manner (e.g. by means of fins 26 engaging longitudinal grooves, not shown, formed inside tubular member 20). Cosmetic lead 17 is interference-fitted inside sleeve 25, at the opposite end to screw 22. By rotating tubular members 19, 20 with respect to each other, cosmetic lead 17 translates axially between an extracted position projecting from one end 16a of supporting body 16, and a withdrawn position housed entirely inside supporting body 16.

Implement 18, which in the FIG. 4 embodiment also comprises a cutter 27 with a V-shaped blade 28, is fitted removably to an end 16b, opposite end 16a, of supporting body 16. More specifically, a base 29 of implement 18 is slightly force-fitted to end 16b, and comprises an inner annular projection 30 engaging an annular groove 31 formed in an outer surface of supporting body 16. That is, annular projection 30 and annular groove 31 define reversible retaining means connecting implement 18 to supporting body 16, so that implement 18 may be changed easily in the event of breakage, or replaced with a different manicure implement (e.g. a file).

Clearly, changes may be made to the cosmetic pencil as described and illustrated herein without, however, departing from the scope of the present invention.

In particular, the cosmetic pencil may comprise different manicure implements, such as a file, orange stick, spatula, or nail cleaner; the manicure implement may be connected to the supporting body by reversible or irreversible retaining means other than those described; the lead feed mechanism may be other than described, e.g. pushbutton-operated; and the supporting body may be made of other than wood or plastic, e.g. of metal.

1) A cosmetic pencil comprising a substantially cylindrical supporting body (2; 16); and a cosmetic lead (3; 17) housed inside the supporting body (2; 16) so as to project from a first end (2a; 16a) of the supporting body (2; 16) at least in an in-use configuration;
characterized in that a second end (2b; 16b), opposite the first end (2a; 16a), of the supporting body (2; 16) is fitted with a manicure implement (4; 18).

2) A pencil as claimed in claim 1, characterized in that said manicure implement (4; 18) comprises a cuticle cutter (11; 27).

3) A pencil as claimed in claim 2, characterized in that said cutter (11; 27) comprises a V-shaped blade (12; 28).

4) A pencil as claimed in claim 1, characterized in that said manicure implement (4; 18) is fitted removably to the second end (2b; 16b) of said supporting body (2; 16).

5) A pencil as claimed in claim 1, characterized in that said cosmetic lead (17) is retractable inside said supporting body (16).

6) A pencil as claimed in claim 5, characterized by comprising relative feed means (23, 24, 25) connected to said cosmetic lead (17) and to said supporting body (16) to translate said cosmetic lead (17) axially between an extracted position, in which the cosmetic lead (17) projects from the supporting body (16), and a withdrawn position, in which the cosmetic lead (17) is housed entirely inside the supporting body (16).

7) A pencil as claimed in claim 6, characterized in that said supporting body (16) comprises two tubular members (19, 20) connected end to end, movable angularly with respect to each other, and internally defining a seat in which the cosmetic lead (7) slides; the relative feed means comprising a nut screw (23) and a screw (24), each connected in angularly fixed manner to a respective tubular member (19, 20).

8) A pencil as claimed in claim 1, characterized by comprising a lead cap (14) fitted removably to the first end (2a; 16a) of the supporting body (2; 16), and having a closed portion (14a) in the form of a spatula.
